(19) United States
(12) Patent Application Publication
(10) Pub. No.: US 2008/0172485 A1
(43) Pub. Date: Jul. 17, 2008

(54) Method and system for rating users of a dating service

(76) Inventor: Jason Du, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/653,152

(22) Filed: Jan. 12, 2007

(51) Int. Cl. G06F 15/173

(52) U.S. Cl. 709/224

(57) ABSTRACT

A collecting user generated rating values for members of a dating service. The method includes monitoring a predetermined number of interactions between a first person and a second person via the service. Once a predetermined number of interactions has taken place, the service allows the first person to provide individual rating values as to one or more qualities of the second person. The site then provides to its members modified rating values which are derived from the individual rating values collected.

### CROSS-REFERENCES TO RELATED APPLICATIONS

Not Applicable

### BACKGROUND OF THE INVENTION

Dating services, designed to help potential companions find each other, have a long history, and take a variety of forms. Well known examples include personal ads placed in newspapers, telephone chat services, and in-person introduction agencies. In recent years, a number of Internet dating services have also formed. These Internet dating services allow two potential companions to chat or communicate with each other via e-mail, instant messaging or the like.

In order to help users find compatible matches, dating services of all types presently rely on information supplied by an individual about himself/herself, in the form of written statements, answers to survey questions, recorded greetings, photographs, and the like. Self-evaluation presents a number of problems, however. First, the information can be unreliable, for a variety of reasons. Some users may exaggerate their positive qualities in order to attract more potential matches, while others may downplay their self descriptions, out of a sense of modesty. Further, users of the site cannot accurately report on the experiences of others who have interacted with them. A need thus exists for dating services to provide a look at their users through other people's eyes.

Some services have made efforts in this direction. For example, allowing textual comments from other users is known to the art. Similarly, allowing numeric rating of users as to various personal qualities (most often physical attractiveness) is known. The trouble with these approaches is there is no way to know whether the comments or ratings given are the result of genuine personal experiences of the commentators. A more comprehensive solution is needed.

Embodiments of the invention address these and other problems, individually and collectively.

### SUMMARY OF THE INVENTION

Embodiments of the invention are directed to systems and methods for providing ratings of users of a dating service generated by other members of the service. Embodiments can be used in all forms of dating services, from phone systems to Web sites.

One embodiment of the invention is directed to a method for allowing a first person to rate a second person as to various personal qualities. The first and second persons may be potential companions affiliated with a dating Web site, or another dating service. The method includes monitoring a number of interactions that occur between the first person and the second person. These interactions are preferably electronic interactions between the first and second persons. Such electronic interactions could be in the form of emails, text messages, telephone calls, message boards, or any other standard interaction offered to users of the service. In some embodiments, the interactions may also include face-to-face meetings.

Once the service verifies that a predetermined number of interactions has occurred, it may receive, from the first person, one or more individual rating values as to one or more qualities of the second person. The individual rating value may be combined with other individual rating values from other persons to form a modified rating value. The modified rating value may be in cumulative form such as an average rating value for all individual rating values received from various persons for a particular person. The modified rating value is then made available to other persons who use the service (e.g., a third person who might consider dating the second person) so that the particular person being rated can be evaluated as a potential companion. The unmodified individual rating values could also be made available to third persons through the service.

In another embodiment, the service may require that a predetermined number of users rate a person before rating values are made available to other members of the service. This step prevents the display of rating values that are too heavily weighted toward the opinion of a single person. If only average rating values are made available to other users, it also provides some level of privacy for individual raters.

These and other embodiments of the invention are described in further detail below.

### BRIEF DESCRIPTION OF THE DRAWINGS

FIG. 1 shows a system according to an embodiment of the invention. Other systems according to embodiments of the invention may include more or less components than are shown.

FIGS. 2(a)-2(c) show flow charts depicting various example embodiment methods according to the invention.

FIGS. 3-5 show example Web pages from a dating Web site using a method according to the invention.

### DETAILED DESCRIPTION

As noted above, embodiments of the invention are directed to a methods for allowing a first person to give an individual rating as to one or more qualities of a second person. The first and second persons may be potential companions affiliated with a dating Web site, although they may be affiliated with a conventional, non-Internet based dating service in other embodiments of the invention.

A method according to an embodiment of the invention includes monitoring a predetermined number of communications between the first and second person. These communications can preferably take a variety of different forms, such as emails, instant messages, telephone calls, message boards, or any other form of interaction capable of being monitored by the service. In other embodiments, the interactions may take place in face-to-face meetings which may be monitored by the service.

The number of interactions required can be set according to the needs and goals of the service, and the type of interaction offered. For example, if a service offers interaction by instant message, a larger number of interactions may be required before individual rating values are accepted by the service, since each instant message sent in not likely to provide a great deal of substantive information. If, on the other hand, the service provides face-to-face meetings, a single interaction may be deemed sufficient to allow a first person to rate a second person. The number may also be selected by the members to be rated. In preferred embodiments, at least 3, 5, 10, 12, or 20 interactions are required before one person may rate another.

Once the required number of interactions has taken place, the service allows the first person to enter an individual rating value as to one or more qualities of the second person. The qualities to be rated could vary widely, depending on the type of service and the needs of its clientele. A simple dating site, for example, may include a relatively small number of characteristics to be rated. A site designed to match singles for marriage, by contrast, may include a much more substantive set of characteristics for which a person is to be rated. Such rating values may correspond to an overall rating for a person, the appearance of the person, the manners of the person, the education of the person, honesty of a person, reliability of a person, etc.

Once the individual rating values have been collected, the service makes them available to other persons using a Web site. The rating values can be presented in a variety of different ways. For example, an average rating value can be displayed to a person using the service, in order to protect the privacy of the persons who have provided rating values. Alternatively, individual rating values can be shown, with links to the rater, so a user of the site can see what different kinds of people think of a potential companion. The Web site may also generate composite or modified rating values or reports, which are derived from the individual rating values received from users.

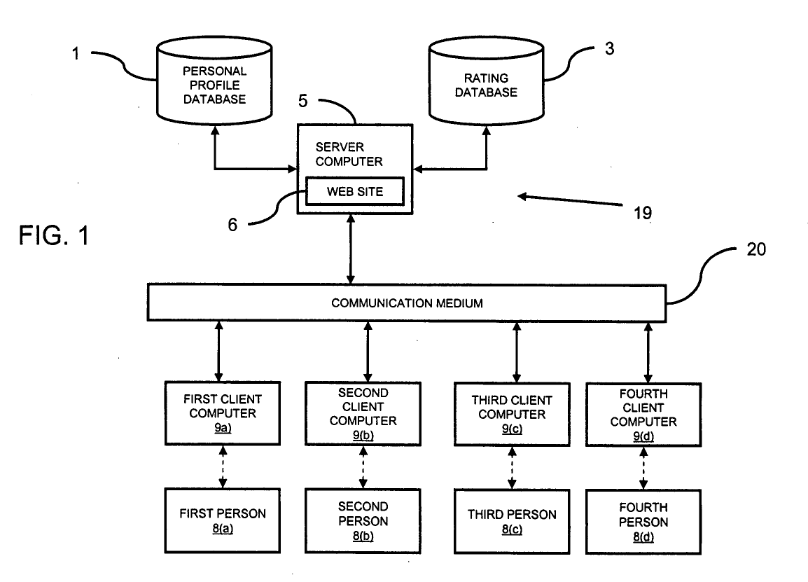

FIG. 1 shows a system according to an embodiment of the invention. The system includes first, second, third, and fourth persons 8(a)-8(d) respectively operating first, second, third, and fourth client computers 9(a)-9(d). The persons 8(a)-8(d) may alternatively be referred to as members or users in other instances, and may be male or female and may be of any suitable socio-economic status (e.g., millionaires). Although four persons 8(a)-8(d) are illustrated, there may be hundreds or even thousands of such persons in other embodiments of the invention.

The client computers 9(a)-9(d) may each include a standard PC (personal computer) with a display, CPU (central processing unit), operating system (e.g., a Windows™ based operating system), hard disk drive, CD-ROM drive, etc. Other examples of client computers may include cellular phones, PDAs, etc. The displays in the client computer 9(a)-9(d) may output forms that allow the persons 8(a)-8(d) to rate other persons and may also output individual or modified rating values of the persons 8(a)-8(d).

The server computer 5 is part of a host service 9 and includes code for operating a Web site 6. The server computer 5 can be in operative communication with the client computers 9(a)-9(d). The Web pages of the Web site 6 may include any number of interactive features including any suitable number of hyperlinks to help guide the user through the Web site 6, and/or selectable buttons. The Web site 6 may also have a number of graphical user interfaces for the user to input information such as his name, grade, preferences, etc. into the system. Browsers on the client computers 9(a)-9(d) permit the persons 8(a)-8(d) to view the Web site 6 and pages thereof. Examples of suitable browsers include Internet Explorer™, which is commercially available from Microsoft. Access to the Web site 6 may be restricted by requiring that any visitors enter an identifier (e.g., a password) to show that the persons accessing the information have proper authorization.

The server computer 5 is typically a powerful computer or cluster of computers. For example, the server computer 5 can be a large mainframe, a minicomputer cluster, or a group of servers functioning as a unit. In one example, the server computer 5 may be a database server coupled to a Web server. Moreover, the server computer 5 can behave as a single computer, which services the requests of one or more client computers. Client computers, such as the client computer 9 can communicate with the server computer 105 through the Internet and optionally through one or more Internet Service Providers (ISPs) (not shown). The client computers 9(a)-9(d) typically have less memory and less computing power than the server computer 5.

The server computer 5 may have access to one or more databases of information. As shown in FIG. 1, the server computer 5 may have access to a personal profile database 1 and a rating database 3. The personal profile database 1 may include a person's personal preferences, images, and characteristics (e.g., educational background, physical characteristics, etc.).

The rating database 3 can contain ranking information for the various persons 8(a)-8(d). The rating information may include individual rating information or modified rating information. As used herein, an “individual rating value” is a rating from one person. The rating value may be in alphanumeric form (e.g., 9 on a scale of 1-10). A “modified rating value” is derived from an individual rating value. For example, the modified rating value may be a combination (e.g., an average) of two or more individual rating values from two or more different persons.

A modified rating value may also be a value that alters an individual rating value in some way. For example, a modified rating value may include an individual rating value that has been altered to “mask” the true individual rating value. This may be done to prevent potential embarrassment to the person being rated, or to prevent the system from giving too much weight to the opinion of a single person. For example, if a first person rates a second person as a “1” on a scale of 1 to 10, the second person may be embarrassed or upset of this value is displayed to others, especially if it is based on single individual's rating. One method of dealing with this issue is simply not to display ratings that fall below a certain threshold value. Alternatively, a modified rating value such as “less than 5” may be displayed in order to mask the true individual ranking value of “1”. Some embodiments may use one of these approaches until a predetermined number of ratings (e.g. more than 25) are received for a given person, at which point the actual rating value is displayed. Others may mask low ratings no matter how many values have been received. The particular approach used will vary according to the needs and goals of the service.

The system, and especially the server computer 5, can include one or more computer programs, written in any suitable computer language. For example, first, second, and third computer programs used for performing three different functions can be embodied in a single computer program having one or more subroutines, or may be embodied by three separate and distinct computer programs. In embodiments of the invention, for instance, the server computer 5 may have one or more computer programs including code for performing any of the functions of the Web site 6 described herein.

The server computer 5 and the client computers 9(a)-9(d) communicate through the electronic communication medium 20. The communication medium 20 may include intranets, or the Internet, and more particularly the World Wide Web (WWW) (or variants thereof). Typical communication protocols include HTTP (hypertext transfer protocol) and TCP/IP (terminal communication protocol/internet protocol). The communication medium 20 may include wired or wireless communication links.

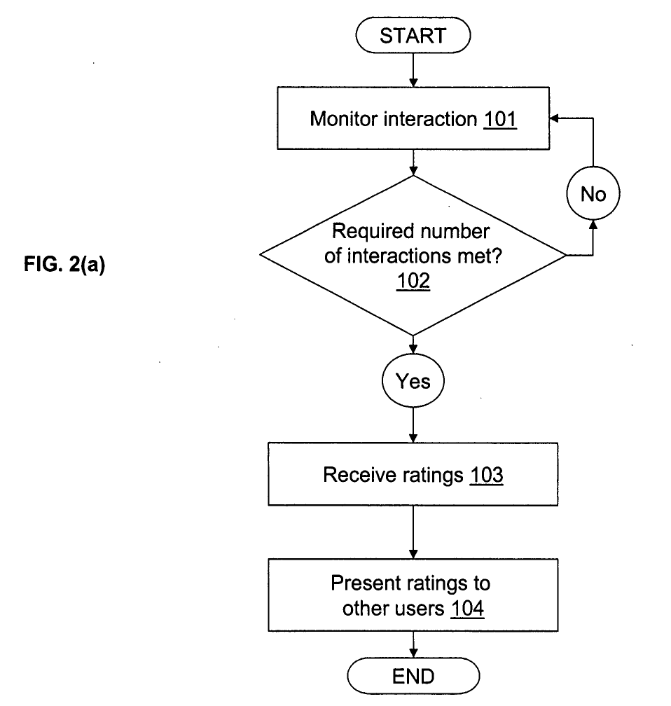

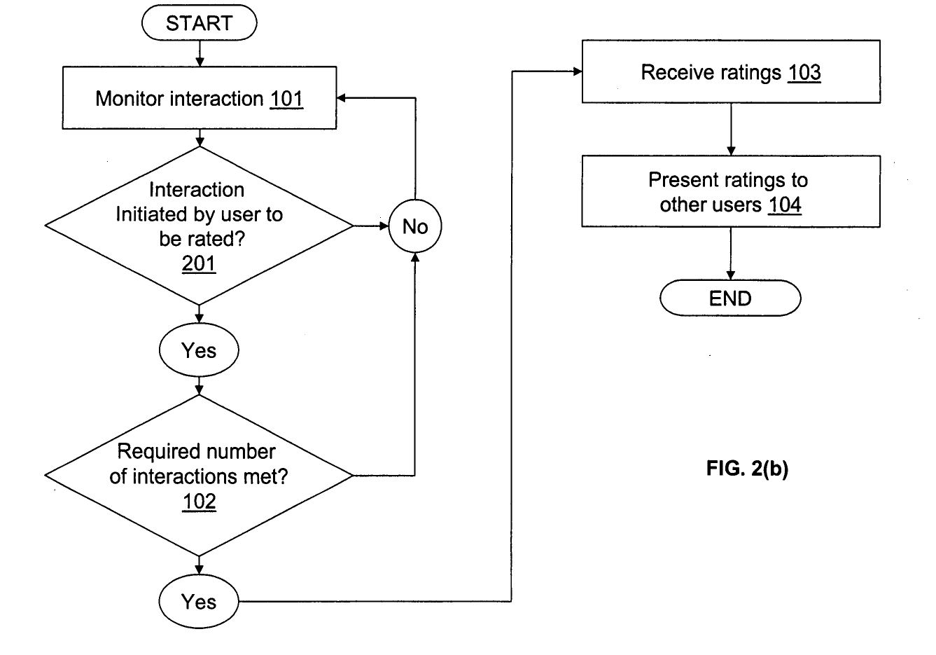

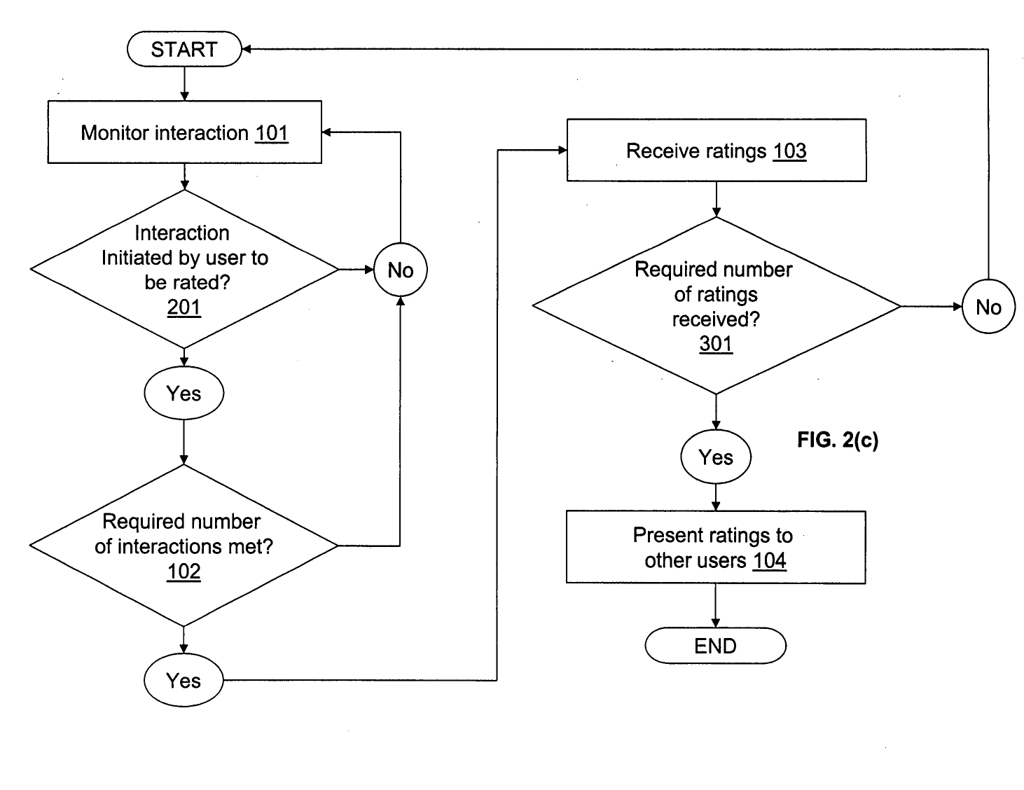

FIG. 2(a) is a flow chart showing one method according to the invention. The method can be used with the system shown in FIG. 1. In the first step 101, the service 19 uses the server computer 5 to monitor an interaction between the first person 8(a) and the second person 8(b). As shown in FIG. 2(a), this first step is repeated until a predetermined number of interactions has taken place. The method then proceeds to the next step 102, where the service 19, using the server computer 5, receives an individual rating from the first person 8(a) about the second person 8(b). Finally, in the third step 103, the service 19, using the server computer 5 and the Web site 6, presents the individual rating to other users (e.g., the third person 8(c) and/or the fourth person 8(d)) of the Web site 6.

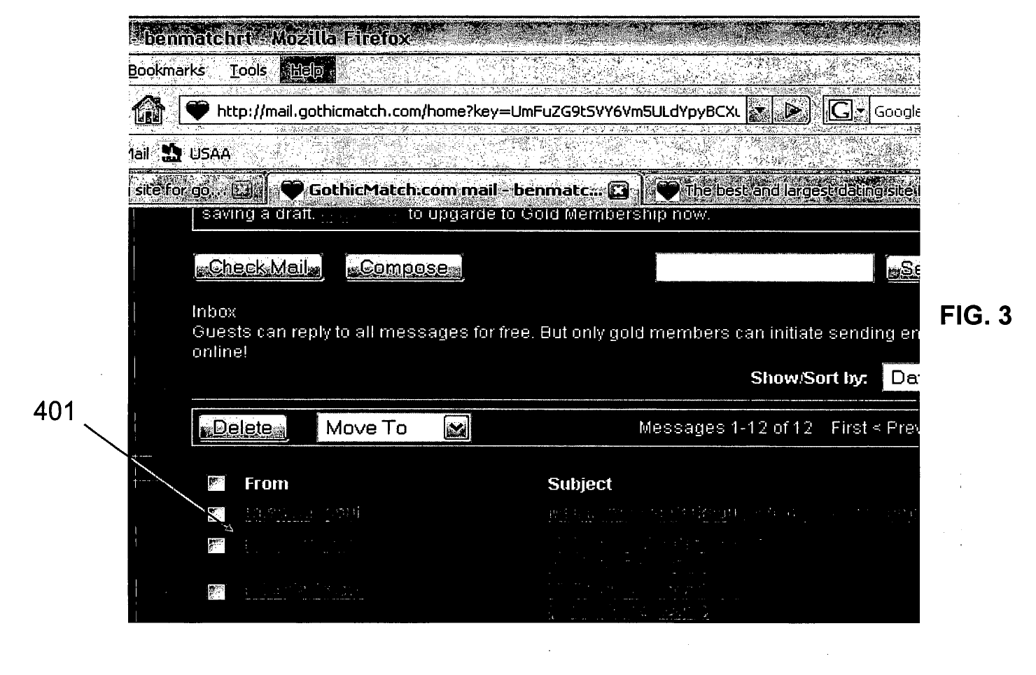

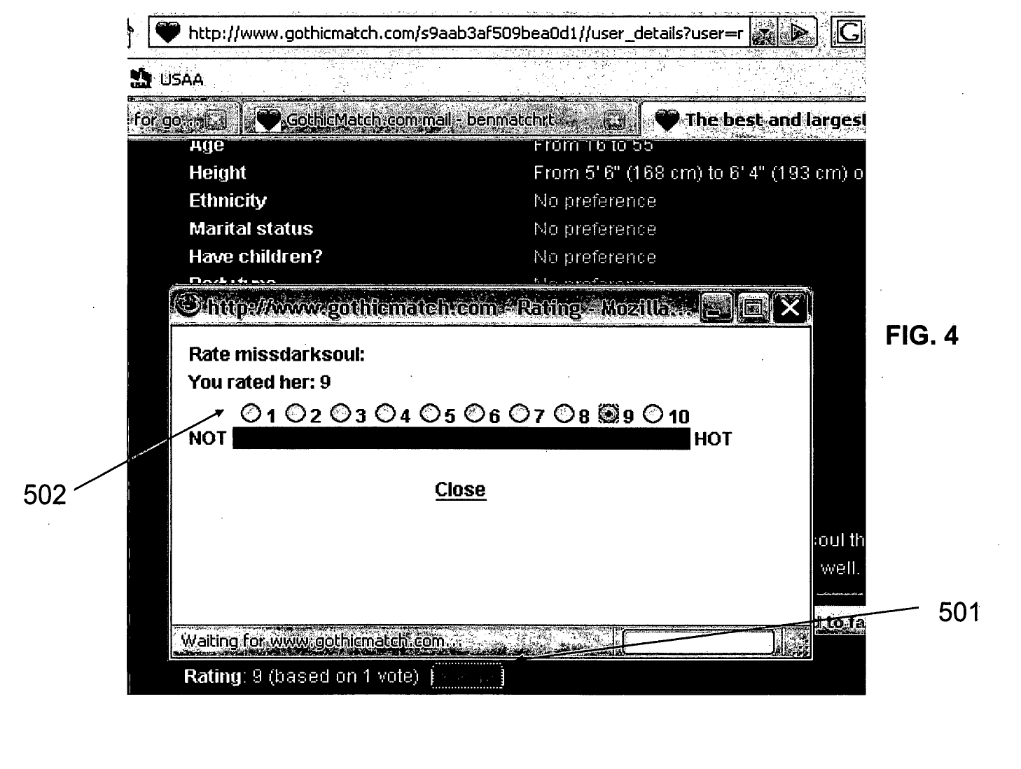

An example of the end result of the first step 101 is depicted in FIG. 3, which is a screen shot of a Web page on the Web site 6. As shown in FIG. 3, a number of interactions 401 have taken place between two persons using the service. In this case the interactions 401 take the form of emails exchanged on the Web site 6. In some embodiments, a single interaction may include at least one initiated message and one reply message back to the person who initiated the message.

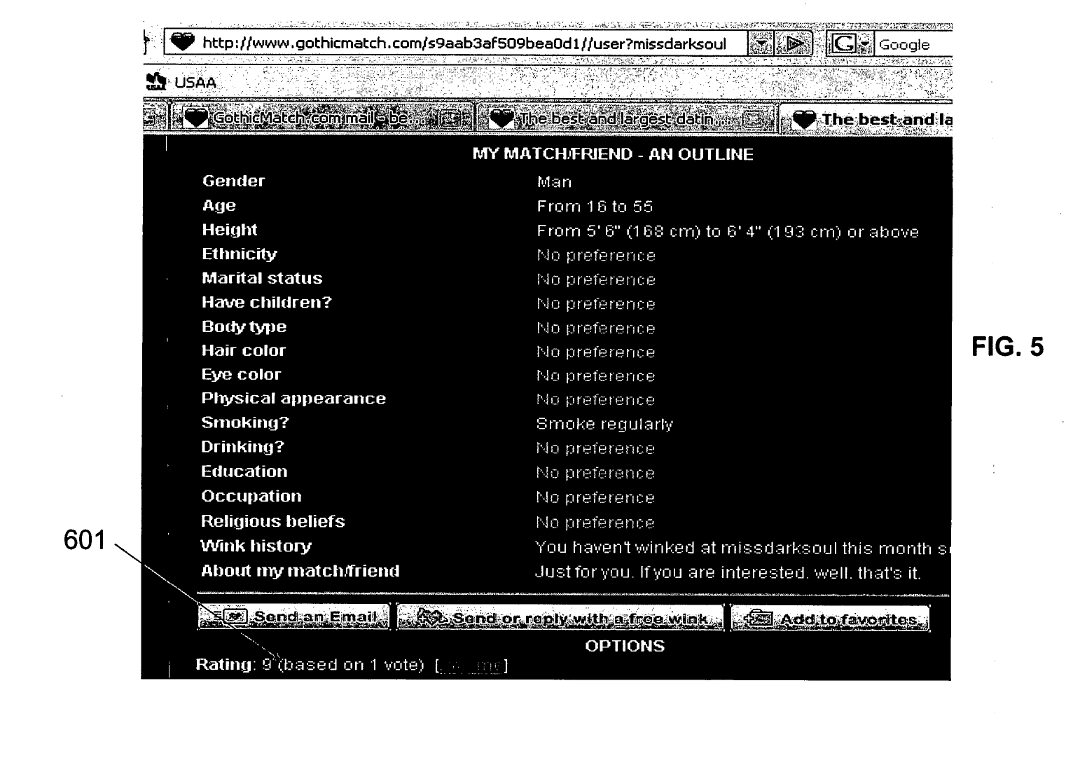

FIG. 5 is another screen shot of a Web page from the Web site 6. It shows an example of the second step 102. In this figure, a first person 8(a) has clicked on a “rate me” link 501 associated with a second person 8(b), with whom the first person 8(a) has had at least the predetermined number of interactions. Selecting the “rate me” link causes the Web site 6 to open a window showing a rating area 502, wherein the first person 8(a) may provide an individual rating for the second person 8(b).

FIG. 6 shows yet another screenshot from a Web page from the Web site 6. It illustrates an example of the third step 103 in FIG. 2(a). In FIG. 6, the Web site 6 presents an average rating value 601 of the second person 8(b), based on the individual rating values it has received from other persons. The average rating value 601 is an example of a modified rating. For example, the average rating value for the second person 8(b) could be the average rating value of the individual rating values provided by the first person 8(a) and the fourth person 8(d). The average rating value may be viewed on the Web site 6 by the third person 8(c).

FIG. 2(b) is a flow chart showing another method according to the invention. In this embodiment, an intermediate step 201 is added to the method of FIG. 1. This step 201 requires that the interactions to be monitored 101 before rating values are received 102 be initiated by the person to be rated. This step can be used to prevent potential abuses of the system, such as a person sending three unanswered emails to a second person, then providing rating values for the second person, which are not based on genuine interactions. The other steps in the illustrated method can be the same as described above, and need not be repeated here.

FIG. 2(c) shows another flow chart according to another embodiment of the invention. This embodiment adds another intermediate step 301, which requires that a pre-determined number of individual rating values 102 as to a particular person be collected before a rating value is provided 103 on the Web site 6 by the service 19. For example, before a modified rating value for the second person 8(b) is provided, the service 19 may require that the second person receive at least 10 individual rating values before it will post the modified rating value associated with the second person 8(b).

Embodiments of the invention have a number of advantages. First, embodiments of the invention allow a user of a dating service to see rating values as to the personal qualities of another user, provided by other members of the service. Second, by requiring a certain amount of interaction to have occurred before receiving rating values, embodiments of the invention provide some level of confidence that the rating values shown are based on genuine knowledge of the person rated.

Any of the above-described methods or steps of such methods may be embodied as software code to be executed by a processor of the server computer or any other suitable combination of devices using any suitable computer language such as, for example, Java, C++ or Perl using, for example, conventional or object-oriented techniques. The software code may be stored as a series of instructions or commands on a computer readable medium, such as a random access memory (RAM), a read only memory (ROM), a magnetic medium such as a hard-drive or a floppy disk, or an optical medium such as a CD-ROM. The computer readable medium may reside on one, or many computational apparatuses.

It should be understood that the present invention can be implemented in the form of control logic, in a modular or integrated manner, using software, hardware or a combination of both. Based on the disclosure and teachings provided herein, a person of ordinary skill in the art will appreciate other ways and/or methods to implement the present invention.

Any of the above-described embodiments and/or any features thereof may be combined with any other embodiment(s) and/or feature(s) without departing from the scope of the invention.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
monitoring a number of interactions that have taken place between a first person and a second person, wherein the first and second persons interact at least once using a host service;
after a predetermined number of interactions has taken place, receiving an individual rating from the first person as to one or more qualities of the second person;
outputting, through the host service, a rating value or a modified rating value for the second person, wherein the rating value or the modified rating value is derived from the individual rating, and wherein the host service is a dating service.

2. The method according to claim 1, further comprising receiving a plurality of individual rating values from a plurality of persons using the host service, and wherein the outputted rating value or modified rating value is derived from the plurality of individual rating values received from the plurality of persons.

3. The method according to claim 1, further comprising providing the host service.

4. The method according to claim 1, wherein the host service comprises a Web site.

5. The method of claim 1 wherein the rating value or the modified rating value is derived from only the individual rating.

6. The method according to claim 1, wherein the rating value or the modified rating value is outputted only after a predetermined number of users provide individual rating values for the second person to the host service.

7. The method according to claim 1, wherein the rating value or the modified rating value is an average value based on individual rating values from a plurality of persons.

8. A computer readable medium comprising:
code for monitoring a number of interactions that have taken place between a first person and a second person, wherein the first and second persons interact at least once using a host service;
code for receiving an individual rating from the first person as to one or more qualities of the second person after a predetermined number of interactions has taken place; and
code for outputting, using the host service, a rating value or a modified rating value for the second person, wherein the rating value or the modified rating value is derived from the individual rating, and wherein the host service is a dating service.

9. A server computer comprising the computer readable medium of claim 8.

10. A method for allowing a first person to interact with a second person via a host site, the method comprising:
interacting with the second person a predetermined number of times; and
providing an individual rating value for the second person based on one or more qualities of the second person using the host service,
wherein the individual rating value or a modified rating value based on the individual rating value is viewable on the host site.

11. The method of claim 10 wherein the predetermined number of times is three or more.

12. The method of claim 10 wherein the host site is a dating Web site.

13. The method of claim 12 wherein the predetermined number of times is three or more.

14. The method of claim 10 wherein the modified rating value is not equal to the individual rating value and masks the true individual rating value.

15. The method of claim 10 wherein the modified rating value is an average value of individual rating values from a plurality of persons who have interacted with the second person equal to or more than the predetermined number of times.

16. A computer readable medium comprising:
code for allowing a first person to interact with the second person a predetermined number of times; and
code for providing an individual rating value for the second person based on one or more qualities of the second person using the host service,
wherein the individual rating value or a modified rating value based on the individual rating value is viewable on the host site.

17. client computer comprising the computer readable medium of claim 16.
